(19) United States
(12) Patent Application Publication
(10) Pub. No.: US 2019/0026304 A1
(43) Pub. Date: Jan. 24, 2019

(54) CONTAINER METADATA SEPARATION FOR CLOUD TIER

(71) Applicant: EMC IP Holding Company LLC, Hopkinton, MA (US)

(72) Inventors: Fani Atanasova Jenkins, Boulder, CO (US); Mahesh Kamat, San Jose, CA (US); Srikant Viswanathan, Pune (IN); Xiongqi Wu, San Jose, CA (US)

(21) Appl. No.: 15/656,713

(22) Filed: Jul. 21, 2017

(51) Int. Cl. G06F 17/30

(52) U.S. Cl. CPC G06F 17/30156; G06F 17/30097

(57) ABSTRACT

A data management device includes a persistent storage and a processor. The persistent storage includes a local object storage. The local object storage includes local data objects, local meta-data objects, and remote meta-data objects. The processor segments a file into file segments, deduplicates the file segments, stores the deduplicated file segments in a remote data object of a remote object storage, and stores meta-data of the deduplicated file segments in a remote meta-data object of the remote meta-data objects.

### BACKGROUND

Computing devices generate, use, and store data. The data may be, for example, images, document, webpages, or meta-data associated with any of the files. The data may be stored locally on a persistent storage of a computing device and/or may be stored remotely on a persistent storage of another computing device.

### SUMMARY

In one aspect, a data management device in accordance with one or more embodiments of the invention includes a persistent storage that includes a local object storage and a processor. The local object storage includes local data objects, local meta-data objects, and remote meta-data objects. The processor segments a file into file segments, deduplicates the file segments, stores the deduplicated file segments in a remote data object of a remote object storage, and stores meta-data of the deduplicated file segments in a remote meta-data object of the remote meta-data objects.

In one aspect, a method of operating a data management device includes segmenting, by the data management device, a file into file segments; deduplicating, by the data management device, the file segments; storing, by the data management device, the deduplicated file segments in a data object of a remote object storage of another computing device; and storing, by the data management device, meta-data of the deduplicated file segments in a meta-data object of a local object storage of the data management device.

In one aspect, a non-transitory computer readable medium in accordance with one or more embodiments of the invention includes computer readable program code, which when executed by a computer processor enables the computer processor to perform a method for operating a data management device, the method includes segmenting, by the data management device, a file into file segments; deduplicating, by the data management device, the file segments; storing, by the data management device, the deduplicated file segments in a data object of a remote object storage of another computing device; and storing, by the data management device, meta-data of the deduplicated file segments in a meta-data object of a local object storage of the data management device.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of a local object storage in accordance with one or more embodiments of the invention.

FIG. 1C shows a diagram of an remote object storage in accordance with one or more embodiments of the invention.

FIG. 2A shows a diagram of an example local data object in accordance with one or more embodiments of the invention.

FIG. 2B shows a diagram of an example local meta-data object in accordance with one or more embodiments of the invention.

FIG. 2C shows a diagram of an example of meta-data in accordance with one or more embodiments of the invention.

FIG. 2D shows a diagram of data relationships in accordance with one or more embodiments of the invention.

FIG. 3A shows a diagram of a file in accordance with one or more embodiments of the invention.

FIG. 3B shows a diagram of a relationship between file segments of a file and the file in accordance with one or more embodiments of the invention.

FIG. 4A shows a flowchart of a method of storing data in an object storage in accordance with one or more embodiments of the invention.

FIG. 4B shows a flowchart of a method of segmenting a file in accordance with one or more embodiments of the invention.

FIG. 4C shows a flowchart of a method of deduplicating file segments in accordance with one or more embodiments of the invention.

FIG. 4D shows a flowchart of a method of storing deduplicated file segments in a remote data object of a remote object storage in accordance with one or more embodiments of the invention.

FIG. 4E shows a flowchart of a method of storing meta-data of deduplicated file segments in a remote meta-data object of a remote object storage and a copy of the remote meta-data object in a local object storage in accordance with one or more embodiments of the invention.

FIG. 5A shows a first portion of an example of storing data in a remote object storage.

FIG. 5B shows a second portion of the example of storing data in the remote object storage.

FIG. 5C shows a third portion of the example of storing data in the remote object storage.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for managing data. More specifically, the systems, devices, and methods may reduce the amount of storage required to store data.

In one or more embodiments of the invention, a data management device may include an object storage. The object storage may store two different types of objects. The first type is a data object that stored portions of files. The second type is a meta-data object that stores information related to the portions of the files stored in data objects. The information related to the portion of the files stored in the objects may include fingerprints of the portions of the files and the size of the portions of the files stored in the data objects.

In one or more embodiments of the invention, the object storage may be a deduplicated storage. Data to-be-stored in the object storage may be deduplicated, before storage, by dividing the to-be-stored data into file segments, identifying file segments that are duplicates of file segments already stored in the object storage, deleting the identified duplicate file segments, and storing the remaining file segments in data objects of the object storage. Meta-data corresponding to the now-stored file segments may be stored in meta-data objects of the object storage. Removing the duplicate file segments may reduce the quantity of storage required to store the to-be-stored data when compared to the quantity of storage space required to store the to-be-stored data without being deduplicated.

In one or more embodiments of the invention, the object storage may utilize the physical storage of the data management device (110) and the physical storage of a remote storage. The data management device may be operably connected to the remote storage.

In one or more embodiments of the invention, both data objects and meta-data objects may be stored in the remote storage. Additionally, a copy of any meta-data objects stored in the remote storage may be present in the data management device. Storing a copy of the meta-data objects in the data management device may reduce the amount of data transmitted via the operable connection between the data management device and the remote storage when performing deduplication or garbage collection operations.

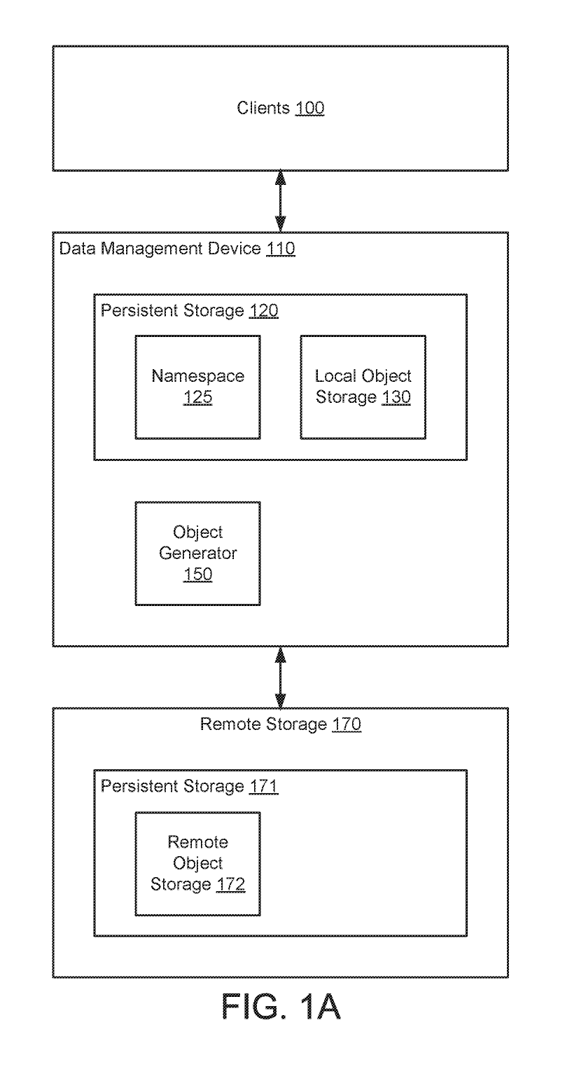

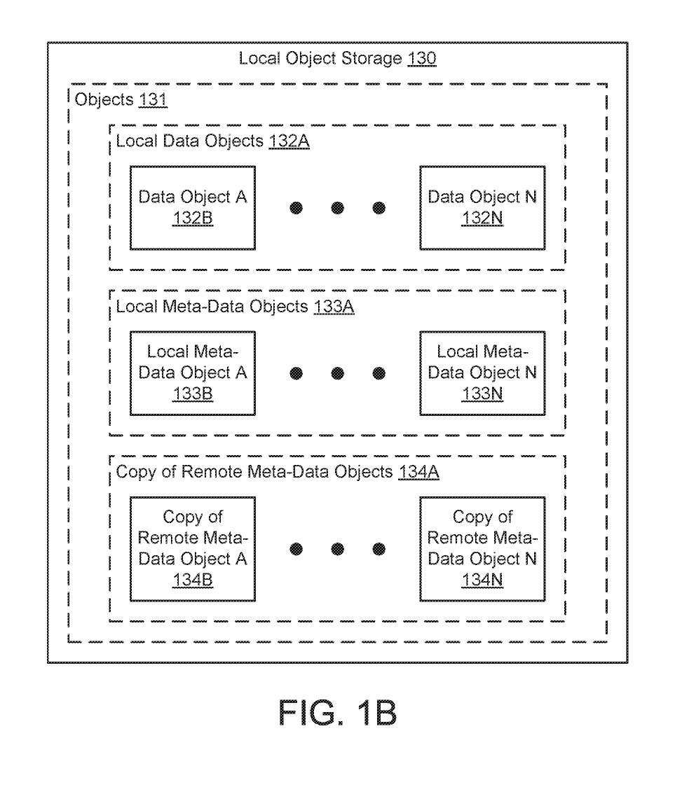

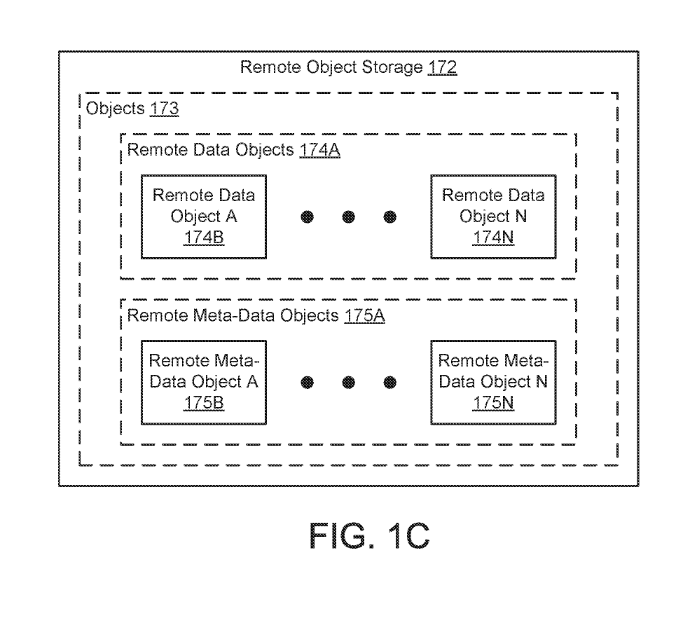

FIG. 1 shows a system in accordance with one or more embodiments of the invention. The system may include clients (100) that store data in the data management device (110). The clients (100) and data management device (110) may be operably connected to each other. The data management device (110) may store some of the data from the clients (100) in a local object storage (130) of the data management device (110) and another portion in a remote storage (170). Each component of the system is discussed below.

The clients (100) may be computing devices. The computing devices may be, for example, mobile phones, tablet computers, laptop computers, desktop computers, servers, or cloud resources. The computing devices may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions described in this. The clients (100) may be other types of computing devices without departing from the invention.

The clients (100) may be programmed to stored data in the data management device (110). More specifically, the clients (100) may send data to the data management device (110) for storage and may request data managed by the data management device (110). The data management device (110) may store the data or provide the requested data in response to such requests.

The remote storage (170) may be a computing device. The computing device may be, for example, a mobile phone, a tablet computer, a laptop computer, a desktop computer, a server, or a cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions described in this. The remote storage (170) may be other types of computing devices without departing from the invention.

The remote storage (170) may be programmed to store data in a persistent storage (171) that includes a remote object storage (172). The remote object storage (172) may be similar to the local object storage (130), discussed in detail below. The remote storage (170) may be a slave storage, i.e., controlled by the local object storage (130) of the data management device (110).

In one or more embodiments of the invention, the remote object storage (172) may be the same storage as the local object storage (130). In other words, the remote object storage (172) may be a portion of the local object storage (130) that spans across persistent storage devices of the data management device (110) and the remote storage (170).

In one or more embodiments of the invention, the remote object storage (172) may be an object storage utilized by the data management device (110). For example, the data management device (110) may send data to the remote storage for storage and the remote storage may store the data in the remote object storage (172).

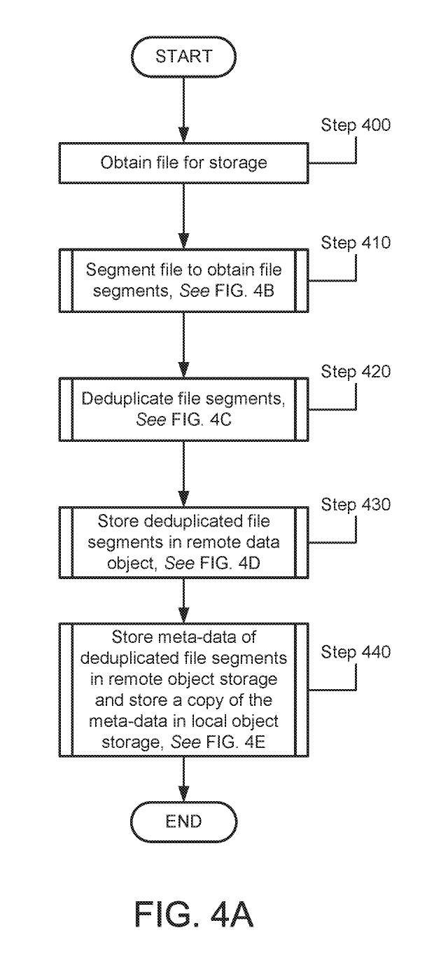

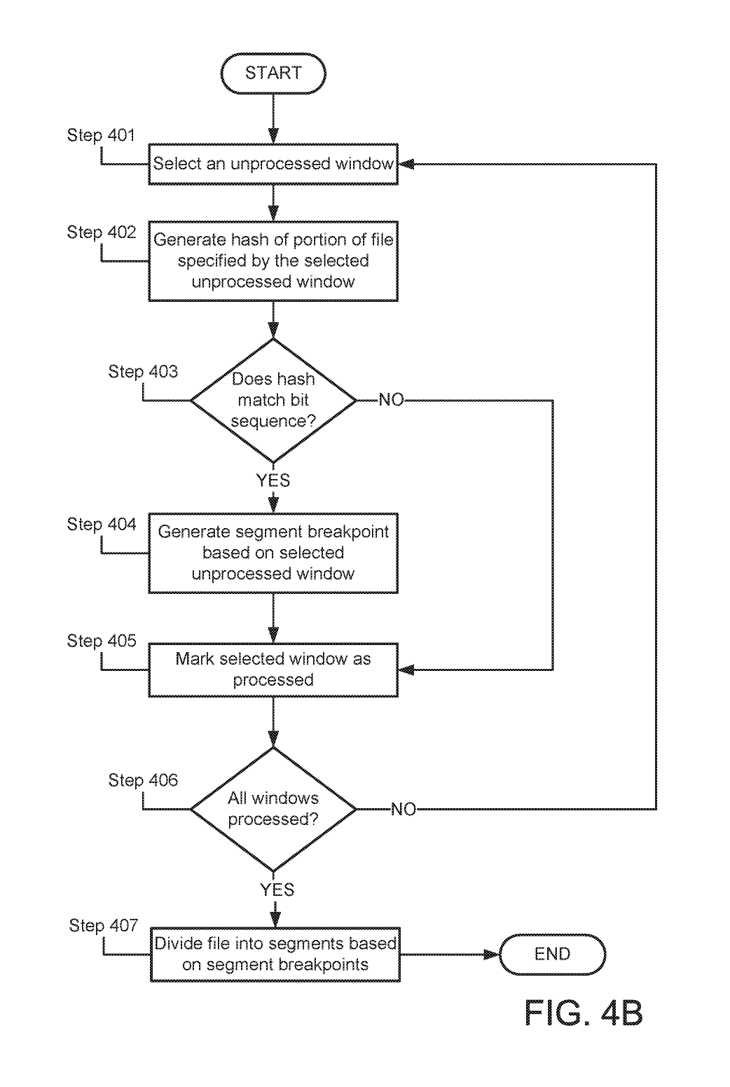

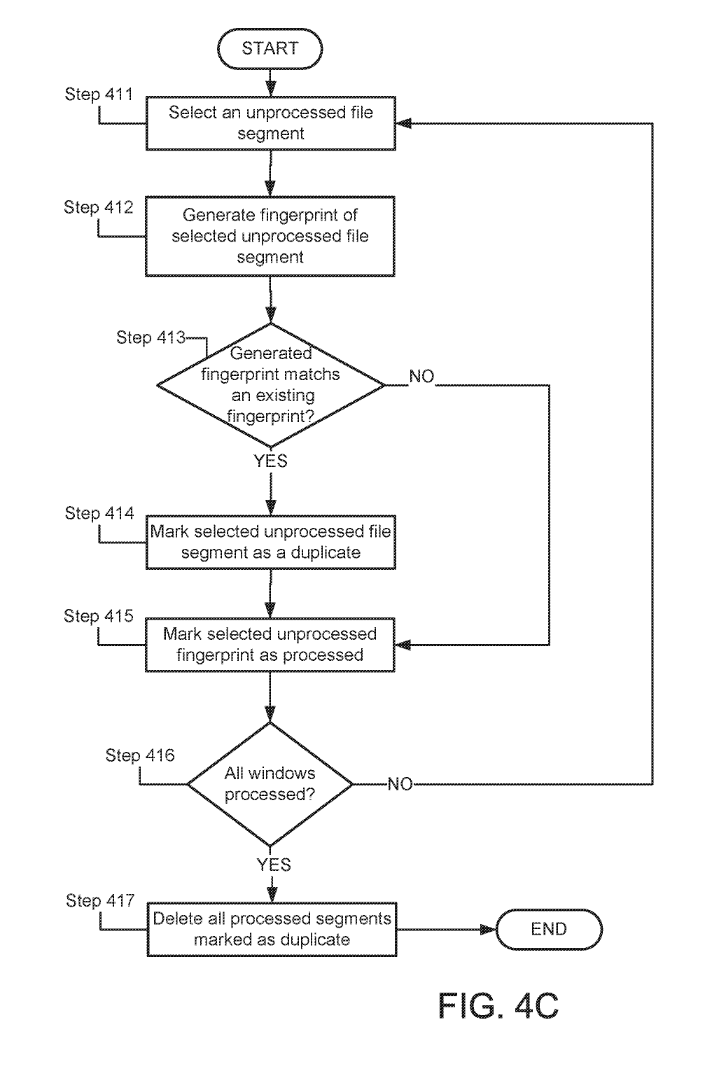

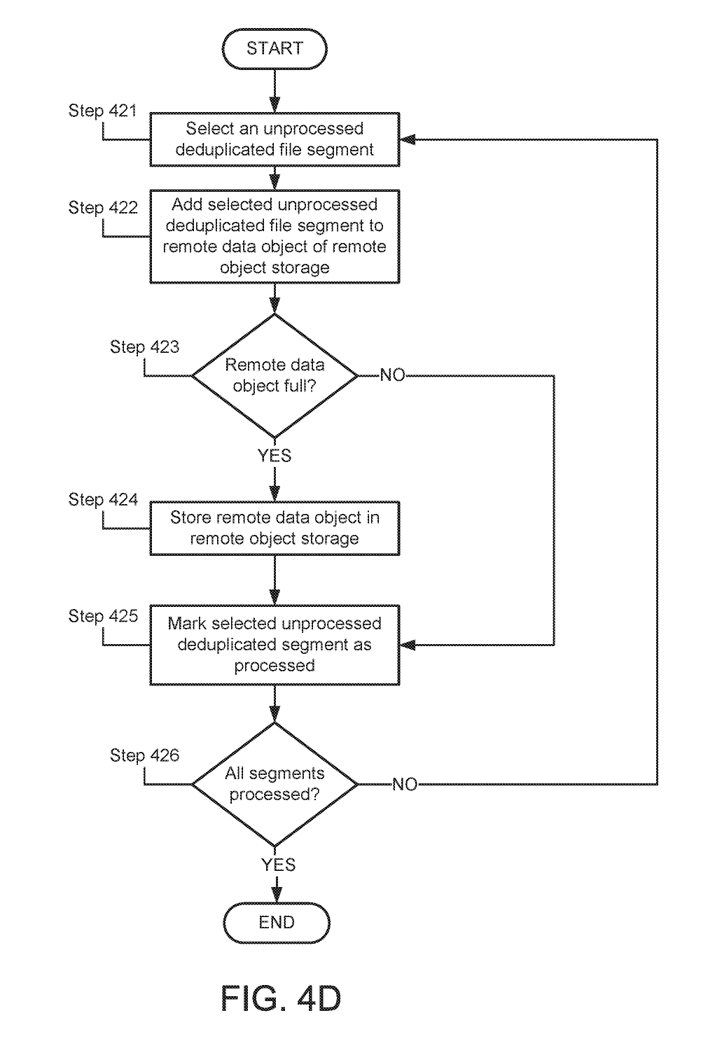

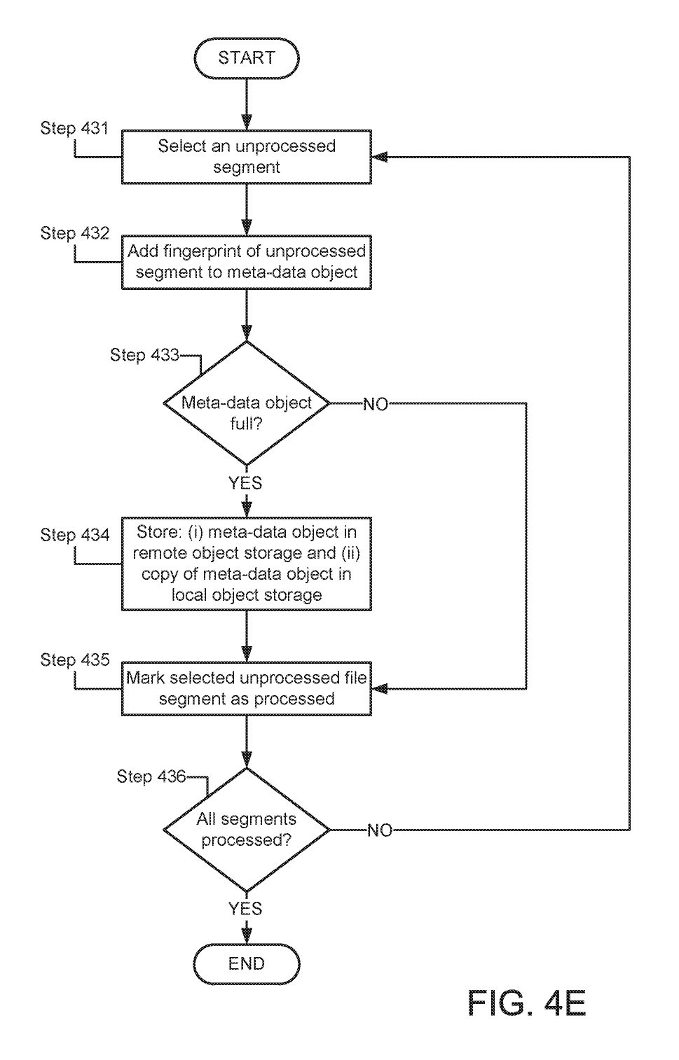

The data management device (110) may be a computing device. The computing device may be, for example, a mobile phone, a tablet computer, a laptop computer, a desktop computer, a server, or a cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions described in this application and illustrated in at least FIGS. 4A-4E. The data management device (110) may be other types of computing devices without departing from the invention.

The data management device (110) may include a persistent storage (120) and an object generator (150). Each component of the data management device (110) is discussed below.

The data management device (110) may include a persistent storage (120). The persistent storage (120) may include physical storage devices. The physical storage devices may be, for example, hard disk drives, solid state drives, tape drives, or any other type of persistent storage media. The persistent storage (120) may include any number and/or combination of physical storage devices.

The persistent storage (120) may include a local object storage (130) for storing data from the clients (100). As used herein, an object storage is a data storage architecture that manages data as objects. Each object may include a number of bytes for storing data in the object. In one or more embodiments of the invention, the object storage does not include a file system. Rather, a namespace (125) may be used to organize the data stored in the object storage. For additional details regarding the local object storage (130), see FIG. 1B.

The persistent storage (120) may include the namespace (125). The namespace (125) may be a data structure stored on physical storage devices of the persistent storage (120) that organizes the data storage resources of the physical storage devices.

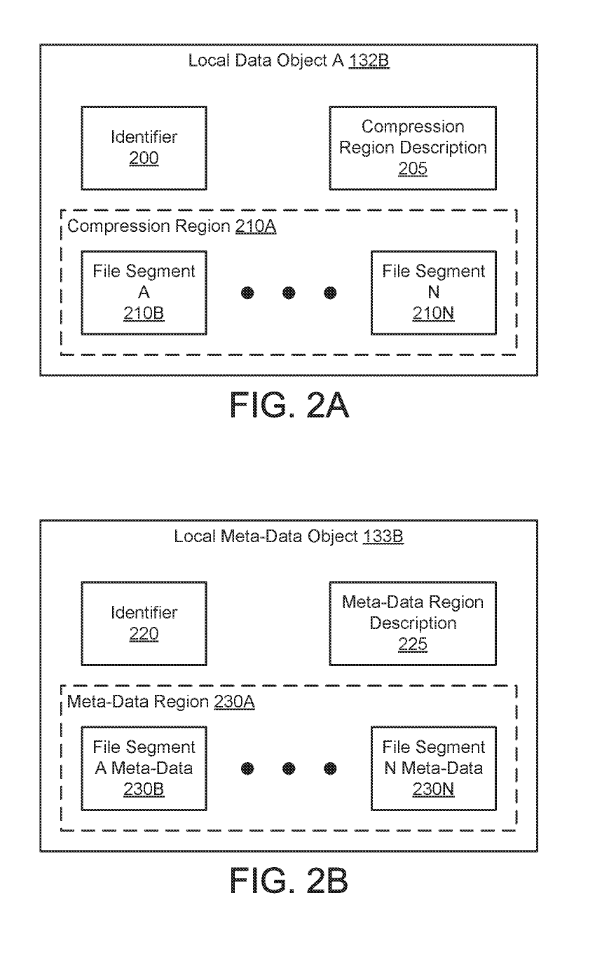

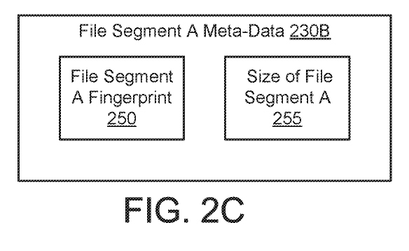

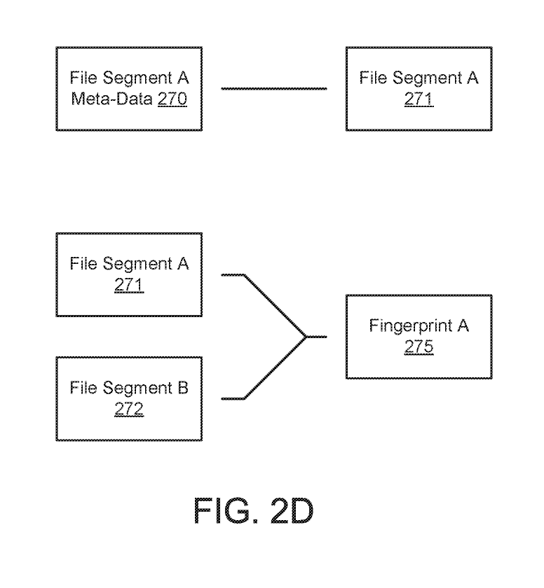

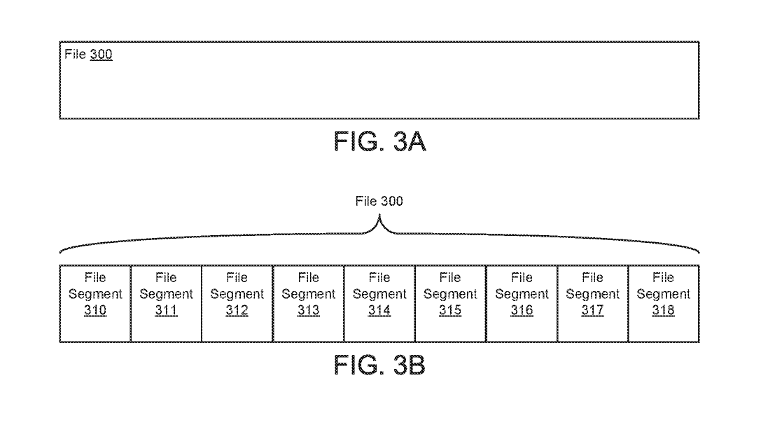

In one or more embodiments of the invention, the namespace (125) may associate a file with a file recipe stored in the persistent storage. The file recipe may be used to generate a file stored in the local object storage (130) using file segments stored in the local object storage (130). Each file recipe may include information that enables a number of file segments to be retrieved from the object storage. The retrieved file segments may be used to generate the file stored in the object storage. For additional details regarding file segments, See FIGS. 2A, 3A, and 3B.

While illustrated as an object storage, the persistent storage (120) may host other storage architectures without departing from the invention. For example, the persistent storage (120) may host a file system including a blockset that organizing the physical storage resources of the persistent storage (120). The blockset may organize the physical storage resources of the persistent storage (120) using any method.

The data management device may include an object generator (150). The object generator (150) may generate objects stored in the local object storage (130). The object generator (150) may generate different types of objects. More specifically, the object generator (150) may generate data objects that store file segments and meta-data objects that store meta-data regarding file segments stored in data objects. For additional details regarding data objects and meta-data objects, See FIGS. 2A-2D.

Additionally, in one or more embodiments of the invention, the persistent storage (120) of the data management device (110) and the persistent storage (171) of the remote storage may be organized using different storage architectures. For example, the persistent storage (171) of the remote storage (170) may host an object storage while the persistent storage (120) of the data management device (110) may host a different file system such as an NSTF, HPFS, FAT, or any other type of file system that organizes the physical resources of the persistent storage (120).

In one or more embodiments of the invention, the object generator (150) may be a physical device. The physical device may include circuitry. The physical device may be, for example, a field-programmable gate array, application specific integrated circuit, programmable processor, microcontroller, digital signal processor, or other hardware processor. The physical device may be adapted to provide the functionality described in this application and to perform the methods shown in FIGS. 4A-4E.

In one or more embodiments of the invention, the object generator (150) may be implemented as computer instructions, e.g., computer code, stored on a persistent storage that when executed by a processor of the data management device (110) cause the data management device (110) to provide the functionality described throughout this application and to perform the methods shown in FIGS. 4A-4E.

As discussed above, the object generator (150) may generate objects. The stored may be stored in the local object storage (130) or the remote object storage (172). FIG. 1B shows a diagram of a local object storage (130) in accordance with one or more embodiments of the invention. The local object storage (130) may be a data structure that organizes stored data in objects.

In one or more embodiments of the invention, the local object storage (130) may include local data objects (132A), local meta-data objects (133A), and a copy of remote meta-data objects (134A). The local data objects (132A) may include file segments of files stored in the persistent storage of the data management device. The local meta-data objects (133A) may include meta-data regarding the file segments stored in the local data objects (132A). The copy of the remote meta-data objects (134A) may include meta-data regarding file segments stored in remote data objects of a remote object storage.

FIG. 2C shows a diagram of a remote object storage (172) in accordance with one or more embodiments of the invention. The remote object storage (172) may store file segments of files in remote data objects (174A) and meta-data of the aforementioned file segments in remote meta-data objects (175A).

As discussed above, file segments and meta-data associated with the file segments may be stored different types of objects. FIGS. 2A and 2B show diagrams of objects in accordance with embodiments of the invention. While the diagrams of FIGS. 2A and 2B are in reference to local data objects and local meta-data objects, remote data object and remote data-objects may be identical in structures.

FIG. 2A shows an example of a data object in accordance with one or more embodiments of the invention. The local data object A (132B) may include an identifier (200), a compression region description (205), and a compression region (210A).

The identifier (200) may be a name, bit sequence, or other information used to identify the data object. The identifier (200) may uniquely identify the data from the other objects of the local object storage.

The compression region description (205) may include description information regarding the compression region (210A). The compression region description (205) may include information that enables file segments stored in the compression region (210A) to be read. The compression region description (205) may include, for example, information that specifies the start of each file segment, the length of each file segment, and/or the end of each file segment stored in the compression region. The compression region description (205) may include other information without departing from the invention.

The compression region (210A) may include any number of file segments (210B-210N). The file segments of the compression region (210A) may be aggregated together. The compression region (210A) may be compressed. The compression of the compression region (210A) may be a lossless compression.

FIG. 2B shows an example of a meta-data object in accordance with one or more embodiments of the invention. The local meta-data object A (133B) may include an identifier (220), a meta-data region description (225), and a meta-data region (230A).

The identifier (220) may be a name, bit sequence, or other information used to identify the data object. The identifier (220) may uniquely identify the data from the other objects of the object storage.

The meta-data region description (225) may include description information regarding the meta-data region (230A). The meta-data region description (225) may include information that enables file segment meta-data stored in the meta-data region (230A) to be read. The meta-data region description (225) may include, for example, information that specifies the start of each file segment meta-data, the length of each file segment meta-data, and/or the end of each file segment meta-data stored in the meta-data region (230A). The meta-data region description (225) may include other information without departing from the invention.

The meta-data region (230A) may include file segment meta-data (230B-230N) regarding file segments stored in one or more data objects of the object storage. The file segment meta-data stored in the meta-data region (230A) may be aggregated together. In one or more embodiments of the invention, the meta-data region (230A) is not compressed.

While not illustrated, remote data objects and remote meta-data objects may be identical structures to the local data object and local meta-data object shown in FIGS. 2A and 2B. More specifically, the remote data object may include file segments of files stored in the remote object storage and the remote meta-data objects may include meta-data associated with the file segments stored in the remote object storage.

As used herein, meta-data of a file segment refers to data associated with the file segment. The data may be derived from the file segment or may be associated with the file segment.

FIG. 2C shows an example of file segment meta-data in accordance with one or more embodiments of the invention. The file segment A meta-data (230B) includes meta-data regarding an associated file segment stored in a data object of the object storage. The file segment A meta-data (230B) includes a file segment A fingerprint (250) and a size of file segment A (255). The file segment A meta-data (230B) may include a fingerprint of the associated file segment. The size of file segment A (255) may specify the size of the associated file segment.

As used herein, a fingerprint of a file segment may be a bit sequence that virtually uniquely identifies the file segment from other file segments stored in the object storage. As used herein, virtually uniquely means that the probability of collision between each fingerprint of two file segments that include different data is negligible, compared to the probability of other unavoidable causes of fatal errors. In one or more embodiments of the invention, the probability is 10̂-20 or less. In one or more embodiments of the invention, the unavoidable fatal error may be caused by a force of nature such as, for example, a tornado. In other words, the fingerprint of any two file segments that specify different data will virtually always be different.

Fingerprints of the file segments stored in the local object storage and/or the remote object storage may be used to deduplicate files for storage in the object storage. To further clarify the relationships between files, file segments, and fingerprints, FIGS. 2D, 3A, and 3B include graphical representations of the relationships.

More specifically, FIG. 2D shows a relationship diagram that illustrate relationships between file segments, meta-data of the file segments, and fingerprints of the meta-data in accordance with one or more embodiments of the invention.

As seen from the diagram, there is a one to one relationship between meta-data regarding a file segment stored in the object storage and the file segment stored in the object storage. In other words, for an example file segment A (271) stored in a local data object of the local object storage, associated file segment A meta-data (270) will be store in a local meta-data object of the object storage. A single copy of the file segment A (271) and the file segment A meta-data (270) is stored in the local object storage.

Additionally, as seen from FIG. 2D, there is a one to many relationship between file segments and fingerprints. More specifically, file segment of different files, or the same file, may have the same fingerprint. For example, a file segment A (271) of a first file and a file segment B (272) of a second file may have the same fingerprint A (275) if both include the same data.

FIG. 3A shows a diagram of a file (300) in accordance with one or more embodiments of the invention. The file (300) may include data. The data may be any type of data, may be in any format, and of any length.

FIG. 3B shows a diagram of file segments (310-318) of the file (300) of the data. Each file segment may include separate, distinct portions of the file (300). Each of the file segments may be of different, but similar lengths. For example, each file segment may include approximately 8 kilobytes of data, e.g., a first file segment may include 8.03 kilobytes of data, the second file segment may include 7.96 kilobytes of data, etc. In one or more embodiments of the invention, the average amount of data of each file segment is between 7.95 and 8.05 kilobytes. A file may be broken up into file segment using the method illustrated in FIG. 4B.

As discussed above, the data management device (110, FIG. 1A) may receive data from clients (100, FIG. 1A) for storage. The data management device (110, FIG. 1A) may store the data in the local object storage (130, FIG. 1A) or the remote object storage (172, FIG. 1A). FIGS. 4A-4E show flowcharts of methods of storing data in the remote object storage (172, FIG. 1A).

FIG. 4A shows a flowchart of a method in accordance with one or more embodiments of the invention. The method depicted in FIG. 4A may be used to store data in a remote object storage in accordance with one or more embodiments of the invention. The method shown in FIG. 4A may be performed by, for example, an object generator (150, FIG. 1A). Other component of the data management device (110) or the illustrated system may perform the method illustrated in FIG. 4A without departing from the invention.

In Step 400, a file is obtained for storage. The file may be obtained by receiving a file storage request from a client that specifies the file.

In Step 410, the file is segmented to obtain file segments. The file may be segmented to obtain file segments by performing the method shown in FIG. 4B. The file may be segmented to obtain file segments using other methods than the method shown in FIG. 4B without departing from the invention.

In Step 420, the file segments are deduplicated. The file segments may be deduplicated using the method shown in FIG. 4C. The file segments may be deduplicated using other methods than the method shown in FIG. 4C without departing from the invention.

In Step 430, the deduplicated file segments are stored in a remote data object of a remote object storage. The file segments may be stored in the remote data object using the method shown in FIG. 4D. The file segments may be stored in a remote data object using other methods than the method shown in FIG. 4D without departing from the invention.

In Step 440, meta-data of the deduplicated file segments are stored in a remote meta-data object of a remote object storage and a copy of the remote meta-data object is stored in a local object storage. The meta-data of the deduplicated file segments may be stored in a remote meta-data object and a copy of the remote meta-data object may be stored in the local storage using the method shown in FIG. 4E. The meta-data of the deduplicated file segments may be stored in a remote meta-data object and a copy of the remote meta-data object may be stored in the local storage using other methods than the method shown in FIG. 4C without departing from the invention.

The method may end following Step 440.

FIG. 4B shows a flowchart of a method in accordance with one or more embodiments of the invention. The method depicted in FIG. 4B may be used to segment a file into file segments in accordance with one or more embodiments of the invention. The method shown in FIG. 4B may be performed by, for example, an object generator (150, FIG. 1A). Other component of the data management device (110) or the illustrated system may perform the method illustrated in FIG. 4B without departing from the invention.

In Step 401, an unprocessed window of a file is selected. As used herein, a window of a portion of the file is a predetermined number of bits of the file. For example, a first window may be the first 1024 bits of the file, a second window may be 1024 bits of the file starting at the second bit of the file, the third window may be 1024 bits of the file starting at the third bit, etc. Each window of the file may be considered to be unprocessed at the start of the method illustrated in FIG. 4B.

In Step 402, a hash of the portion of the file specified by the unprocessed window is obtained. In one or more embodiments of the invention, the hash may be a cryptographic hash. In one or more embodiments of the invention, the cryptographic hash is a secure hash algorithm 1 (SHA-1) hash. In one or more embodiments of the invention, the cryptographic hash is a secure hash algorithm 2 (SHA-2) or a secure hash algorithm 3 (SHA-3) hash. Other hashes may be used without departing from the invention.

In Step 403, hash is compared to a predetermined bit sequence. If the hash matches the predetermined bit sequence, the method proceeds to Step 404. If the hash does not match the predetermined bit sequence, the method proceeds to Step 405.

In one or more embodiments of the invention, the predetermined bit sequence includes the same number of bits as the hash. The predetermined bit sequence may be any bit pattern. The same bit pattern may used each time a hash is compared to the bit sequence in the method shown in FIG. 4B.

In Step 404, a segment breakpoint may be generated based on the selected unprocessed window. The segment breakpoint may specify a bit of the file. The bit of the file may be the first bit of the file specified by the unprocessed window.

In Step 405, the selected unprocessed window is marked as processed. The selected unprocessed window may be marked as unprocessed by, for example, incrementing a bookmark that specifies a bit of the file to the next bit of the file.

In Step 406, it is determined whether all of the windows of the file are processed. If all of the windows of the file are processed, the method may proceed to Step 407. If all of the windows of the file are not processed, the method may proceed to Step 401.

In one or more embodiments of the invention, the length of the window and the bookmark that specifies the bit of the file may be used to determine whether all of the windows are processed. Specifically, the bookmark and the length of the window may be used to determine whether the window would exceed the length of the file.

In Step 407, the file is divided into file segments using the segment breakpoints. As discussed above, the segment breakpoints may specify bits of the file. The file may be broken into file segments starting and ending at each of the breakpoints.

The method may end following Step 407.

In one or more embodiments of the invention, the method shown in FIG. 4B may be described as performing a rolling hash of the file. Performing the rolling hash may generate hashes, i.e., bit sequences, corresponding to portions of the file. Each portion of the file may start at a different bit of the file and include the same number of bits. Each of the generated hashes may be compared to a predetermined bit sequence and thereby generate segment breakpoints. Each time a file is segmented using the method shown in FIG. 4B, the same predetermined bit sequence may be used in Step 403. Using the same bit sequence in Step 403 will increase the likelihood that file are segmented similarly each time copies of the file are segmented.

FIG. 4C shows a flowchart of a method in accordance with one or more embodiments of the invention. The method depicted in FIG. 4C may be used to deduplicate file segments of a file in accordance with one or more embodiments of the invention. The method shown in FIG. 4C may be performed by, for example, an object generator (150, FIG. 1A). Other component of the data management device (110) or the illustrated system may perform the method illustrated in FIG. 4C without departing from the invention.

In Step 411, an unprocessed file segment of a file is selected. At the start of the method illustrated in FIG. 4C, all of the file segments of a file may be considered to be unprocessed.

In Step 412, a fingerprint of the selected unprocessed file segment is generated. In one or more embodiments of the invention, the fingerprint of the unprocessed file segment is generated using Rabin's fingerprinting algorithm. In one or more embodiments of the invention, the fingerprint of the unprocessed file segment is generated using a cryptographic hash function. The cryptographic hash function may be, for example, a message digest (MD) algorithm or a secure hash algorithm (SHA). The message MD algorithm may be MD5. The SHA may be SHA-0, SHA-1, SHA-2, or SHA3. Other fingerprinting algorithms may be used without departing from the invention.

In Step 413, it is determined whether the generated fingerprint matches an existing fingerprint of a copy of a remote meta-data object stored in the local object storage. If the generated fingerprint matches an existing fingerprint, the method proceeds to Step 414. If the generated fingerprint does not match an existing fingerprint, the method proceeds to Step 405.

In one or more embodiments of the invention, the generated fingerprint is only a matched to a portion of the fingerprints stored in copies of remote meta-data objects stored in the local object storage. For example, only fingerprints stored in a portion of the copies of the remote meta-data objects of the local object storage may be loaded into memory and used as the basis for comparison of the generated fingerprint.

In Step 414, the selected unprocessed file segment is marked as a duplicate.

In Step 415, the selected unprocessed file segment is marked as processed.

In Step 416, it is determined whether all of the file segments of the file are processed. If all of the windows of the file segments of the file are processed, the method may proceed to Step 417. If all of the windows of the file segments of the file are not processed, the method may proceed to Step 411.

In Step 417, all of the file segments marked as duplicate are deleted. The remaining file segments, i.e., the file segments not deleted in Step 417, are the deduplicated file segments.

The method may end following Step 417.

FIG. 4D shows a flowchart of a method in accordance with one or more embodiments of the invention. The method depicted in FIG. 4D may be used to store deduplicate file segments in a remote object storage in accordance with one or more embodiments of the invention. The method shown in FIG. 4D may be performed by, for example, an object generator (150, FIG. 1A). Other component of the data management device (110) or the illustrated system may perform the method illustrated in FIG. 4D without departing from the invention.

In Step 421, an unprocessed deduplicated file segment is selected. At the start of the method illustrated in FIG. 4D, all of the file segments may be considered to be unprocessed.

In Step 422, the selected unprocessed deduplicated file segment is added to a remote data object of a remote object storage.

In one or more embodiments of the invention, the selected unprocessed deduplicated file segment may be added to a compression region of the remote data object. The unprocessed deduplicated file segment may be compressed before being added to the compression region. The compression region description of the remote data object may be updated based on the addition. More specifically, the start, length, and/or end of the deduplicated file segment within the remote data object may be added to the compression region description. Different information may be added to the compression region description to update the compression region description without departing from the invention.

In Step 423, it is determined whether the remote data object is full. If the remote data object is full, the method proceeds to Step 424. If the remote data object is not full, the method proceeds to Step 425.

The remote data object may be determined to be full based on the quantity of data stored in the compression region. More specifically, the determination may be based on a number of bytes required to store the compressed file segments of the compression region. The number of bytes may be a predetermined quantity of bytes such as, for example, 5 megabytes.

In Step 424, the remote data object is stored in the remote object storage.

In one or more embodiments of the invention, the file segments of the compression region may be compressed before the remote data object is stored in the remote object storage.

In Step 425, the selected unprocessed deduplicated file segment is marked as processed.

In Step 426, it is determined whether all of the deduplicated file segments are processed. If all of the deduplicated file segments are processed, the method may end following Step 426. If all of the deduplicated file segments are not processed, the method may proceed to Step 421.

FIG. 4E shows a flowchart of a method in accordance with one or more embodiments of the invention. The method depicted in FIG. 4E may be used to store meta-data in a remote object storage in accordance with one or more embodiments of the invention. The method shown in FIG. 4E may be performed by, for example, an object generator (150, FIG. 1A). Other component of the data management device (110) or the illustrated system may perform the method illustrated in FIG. 4E without departing from the invention.

In Step 431, an unprocessed deduplicated file segment is selected. At the start of the method illustrated in FIG. 4E, all of the deduplicated file segments may be considered to be unprocessed.

In Step 432, a fingerprint of the selected unprocessed deduplicated file segment is added to a meta-data object. The meta-data object may be a remote meta-data object.

In one or more embodiments of the invention, the fingerprint of the selected unprocessed deduplicated file segment may be added to a meta-data region of a remote meta-data object. The meta-data region description of the remote meta-data object may be updated based on the addition. More specifically, the start, length, and/or end of the fingerprint within the remote meta-data object may be added to the meta-data region description. Different information may be added to the meta-data region description to update the meta-data region description without departing from the invention. For example, a size of the selected unprocessed deduplicated file segment may be added to the meta-data region, in addition to the fingerprint, without departing from the invention.

In Step 433, it is determined whether the meta-data object is full. If the meta-data object is full, the method proceeds to Step 434. If the meta-data object is not full, the method proceeds to Step 435.

The meta-data object may be determined to be full based on the quantity of data stored in the meta-data region. More specifically, the determination may be based on a number of bytes required to store the meta-data of the meta-data region. The number of bytes may be a predetermined quantity of bytes such as, for example, 5 megabytes.

In Step 434, the meta-data object is stored in a remote object storage as a remote meta-data object and a copy of the remote meta-data object is stored in the local object storage.

In Step 435, the selected unprocessed deduplicated file segment is marked as processed.

In Step 436, it is determined whether all of the deduplicated file segments are processed. If all of the deduplicated file segments are processed, the method may end following Step 436. If all of the deduplicated file segments are not processed, the method may proceed to Step 431.

While illustrated as separate methods in FIGS. 4D and 4E, embodiments of the invention are not limited to separately performed methods. For example, both of the methods may be performed at the same time. Steps 432-435 may be performed in coordination with Step 422-425 of FIG. 4D.

The following is an explanatory example. The explanatory example is included for purposes of explanation and is not limiting.

### Example

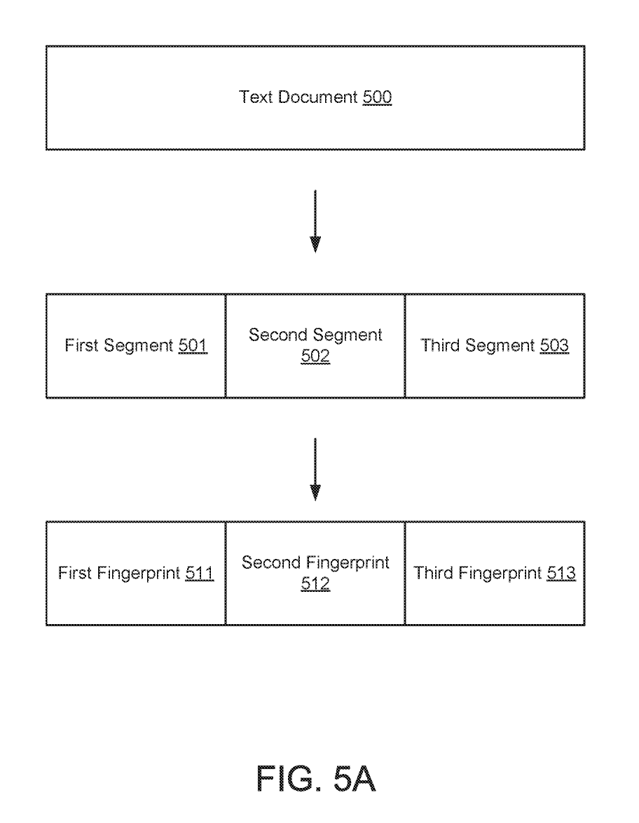

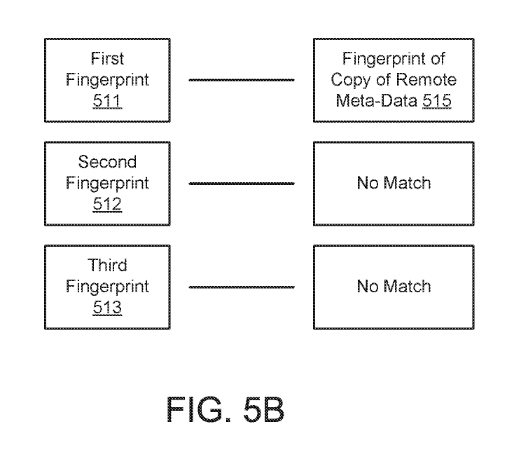

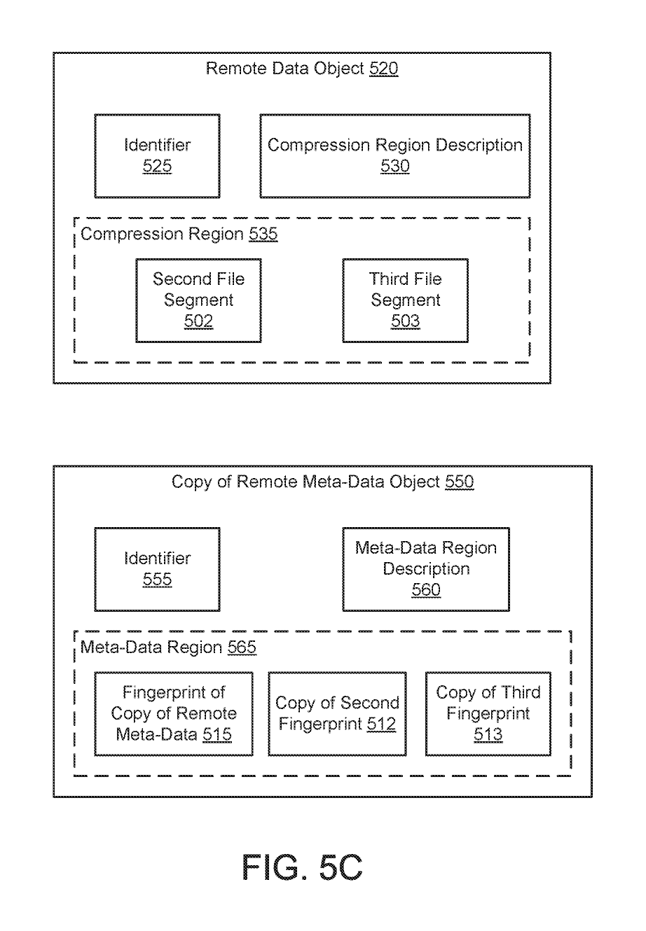

A client send a data storage request to a data management device. The data storage request specifies a text document (500) as shown in FIG. 5A. Based on the request the data management devices elects to store the text document (500) in a remote object storage rather than a local object storage.

In response to the data storage request, the data management device obtains the requested text document (500). The text document may be, for example, a word document including a final draft of a report documenting the status of a project. A previous draft of the report documenting the status of the project is already stored in the remote object storage.

The data management device segments the file into a first file segment (501), a second file segment (502), and a third file segment (503). The data management device generates a first fingerprint (511) of the first file segment (501), a second fingerprint (512) of the second file segment (502), and a third fingerprint (513) of the third file segment (503). The first file segment includes an introductory portion of the report that was not changed from the draft of the report. The second file segment includes a required materials portion of the report that was changed from the draft of the report. The third file segment includes a project completion timeline that was changed from the draft of the report.

The file segments (511-513) are then deduplicated. During deduplication shown in FIG. 5B, the data management device matched the first fingerprint (511) to a fingerprint stored in a copy of a remote meta-data (515) corresponding to a file segment of the draft report that included the introduction section of the report stored in a remote object storage. The second fingerprint (512) and third fingerprint (513) did not match any fingerprints in the remote object storage.

Based on the match, only the second file segment (502) and third file segment (503) were added to a remote data object (520) for storage in the remote object storage as shown in FIG. 5C. The first file segment (501) was deleted. Similarly, only the second fingerprint (512) and third fingerprint (513) were added to a copy of a remote meta-data object (550) stored in the local object storage.

The example ends following the storage of the remote data object (520), the copy of the remote meta-data object (550) in the local object storage, and the remote meta-data object (550) in the remote object storage.

Thus, as illustrated in FIGS. 5A-5C, files may be deduplicated against data stored in a remote object storage using only data, e.g., copies of remote meta-data objects, stored in a local object storage.

One or more embodiments of the invention may be implemented using instructions executed by one or more processors in the data storage device. Further, such instructions may correspond to computer readable instructions that are stored on one or more non-transitory computer readable mediums.

One or more embodiments of the invention may enable one or more of the following: i) reduce the bandwidth cost of deduplicating a file against a remote object storage, ii) improve a rate of deduplicating files against a remote object storage by using copies of meta-data of file segments of files stored in remote object storage that are stored on a local object storage, and iii) enable global deduplication of a file against a multitude of remote storages using a centralized repository of meta-data.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A data management device, comprising:
a persistent storage comprising a local object storage comprising:
a plurality of local data objects,
a plurality of local meta-data objects, and
a plurality of remote meta-data objects; and
a processor programmed to:
segment a file into a plurality of file segments;
deduplicate the plurality of file segments;
store the deduplicated file segments in a remote data object of a remote object storage; and
store meta-data of the deduplicated file segments in a remote meta-data object of the plurality of remote meta-data objects.

2. The data management device of claim 1, wherein the plurality of local data objects comprise segments of files stored in the local object storage.

3. The data management device of claim 1, wherein the plurality of local meta-data objects comprise meta-data of segments of files stored in the local object storage.

4. The data management device of claim 1, wherein the plurality of remote meta-data objects comprise meta-data of segments of files stored in the remote storage.

5. The data management device of claim 4, wherein copies of the segments of files stored in the remote object storage are not stored in the local object storage.

6. The data management device of claim 1, wherein the remote object storage comprises a persistent storage of a computing device different from the data management device.

7. The data management device of claim 1, wherein the remote data object comprises:
a first plurality of segments associated with the file; and
a second plurality of segments associated with a second file.

8. The data management device of claim 7, wherein the remote data object further comprises:
a compression region descriptor that specifies the contents of a compression region comprising the first plurality of segments and the second plurality of segments.

9. The data management device of claim 1, wherein the remote meta-data object comprises:
meta-data of file segments associated with the file; and
meta-data of file segments associated with a second file.

10. The data management device of claim 9, wherein the meta-data of file segments associated with the file comprises a fingerprint of a file segment stored in the remote object storage, wherein the meta-data of file segments associated with the file specifies a size of the file segment stored in the remote object storage.

11. The data management device of claim 9, wherein the remote meta-data object comprises:
a meta-data region descriptor that specifies the contents of a meta-data region of the remote-meta data object comprising the meta-data of file segments associated with the file and the meta-data of file segments associated with the second file.

12. The data management device of claim 11, wherein the meta-data region is not compressed.

13. The data management device of claim 1, wherein segmenting the file into a plurality of file segments comprises:
generating a rolling hash of the file;
selecting a plurality of segment breakpoints based on the rolling hash; and
dividing the file into the plurality of file segments based on the segment breakpoints.

14. The data management device of claim 1, wherein deduplicating the plurality of file segments comprises:
generating a fingerprint of a first file segment of the plurality of file segments;
matching the fingerprint to a plurality of fingerprints stored in the local object storage;
making a determination that the fingerprint matches a fingerprint of the plurality of fingerprints; and
deleting the first file segment based on the determination.

15. The data management device of claim 14, wherein the plurality of fingerprints are stored in the plurality of local meta-data objects, and the plurality of remote meta-data objects.

16. A method of operating a data management device, comprising:
segmenting, by the data management device, a file into a plurality of file segments;
deduplicating, by the data management device, the plurality of file segments;
storing, by the data management device, the deduplicated plurality of file segments in a data object of a remote object storage of another computing device; and
storing, by the data management device, meta-data of the deduplicated file segments in a meta-data object of a local object storage of the data management device.

17. The method of claim 16, wherein deduplicating the plurality of file segments comprising:
generating, by the data management device, a fingerprint of a first file segment of the plurality of file segments;
matching, by the data management device, the fingerprint to a plurality of fingerprints stored in meta-data objects of the local object storage;
making, by the data management device, a determination that the fingerprint matches a fingerprint of the plurality of fingerprints based on the match; and
deleting, by the data management device, the first file segment based on the determination.

18. The method of claim 16, wherein deduplicating the plurality of file segments comprising:
generating, by the data management device, a fingerprint of a first file segment of the plurality of file segments;
matching, by the data management device, the fingerprint to a plurality of fingerprints stored in meta-data objects of the local object storage;
making, by the data management device, a determination that the fingerprint does not matches any fingerprint of the plurality of fingerprints based on the match; and
selecting, by the data management device, the first file segment for storage in the remote object storage.

19. A non-transitory computer readable medium comprising computer readable program code, which when executed by a computer processor enables the computer processor to perform a method for operating a data management device, the method comprising:
segmenting, by the data management device, a file into a plurality of file segments;
deduplicating, by the data management device, the plurality of file segments;
storing, by the data management device, the deduplicated plurality of file segments in a data object of a remote object storage of another computing device; and
storing, by the data management device, meta-data of the deduplicated file segments in a meta-data object of a local object storage of the data management device.

20. The non-transitory computer readable medium of claim 19, wherein deduplicating the plurality of file segments comprising:
generating, by the data management device, a fingerprint of a first file segment of the plurality of file segments;
matching, by the data management device, the fingerprint to a plurality of fingerprints stored in meta-data objects of the local object storage;
making, by the data management device, a determination that the fingerprint matches a fingerprint of the plurality of fingerprints based on the match; and
deleting, by the data management device, the first file segment based on the determination.
